(19) United States
(12) Patent Application Publication
(10) Pub. No.: US 2005/0121136 A1
(43) Pub. Date: Jun. 9, 2005

(54) Surface-decorating method for plastic articles

(76) Inventor: Osvaldo Valmassoi, Domegge di Cadore (IT)

Correspondence Address: WENDEROTH, LIND & PONACK, L.L.P., 2033 K STREET N. W., SUITE 800, WASHINGTON, DC, 20006-1021, US

(21) Appl. No.: 10/819,156

(22) Filed: Apr. 7, 2004

(30) Foreign Application Priority Data
Dec. 3, 2003 (IT) TV 2003 A 000154.

(51) Int. Cl. B44C 1/00

(52) U.S. Cl. 156/241; 264/132

(57) ABSTRACT

Surface-decorating method for articles made of a plastic material, comprising the steps of applying a layer of lacquer or resin on said plastic material, in which said lacquer or resin becomes receptive at a temperature (T_{f}) that is lower than the softening point of the plastic material and applying a support comprising the decoration onto the plastic material. The assembly constituted by the support and the plastic material is subsequently heated up in an ambient at pressure is lower than or equal to the atmospheric one, until a temperature is reached, at which the lacquer or resin becomes receptive.

### BACKGROUND OF THE INVENTION

The present invention refers to a method for surface-decorating plastic articles after manufacture with decorative patterns or embellishments.

The need of decorating (small) plastic articles is sharply felt throughout the industry nowadays. Suffice it to think of the all-pervasive use that is being made of plastics and the fact that, apart from and regardless of the functional characteristics thereof, each product must be aesthetically appealing in order to attract the buyers and meet their tastes. In this connection, a prior-art technique calls for the decorations to be provided and set out on paper sheets through the use of disperse dyes comprised in so-called “sublimatic” inks, which have the property of converting from the solid state to the vapour phase at a certain temperature, i.e. the so-called “sublimation temperature”. Upon laying down said paper sheets upon the articles to be decorated, the article-and-sheet assemblies are loaded in an oven, at a temperature at which the disperse dye sublimates for transferring from the sheet to the material of which the article is made, on which the desired decoration is in this way deposited.

A disadvantage of this method lies in the fact that the sublimation temperature of the dyes, which shall be generally referred to as Tₛ from now on, may be quite high, so that, if the article to be decorated is made of plastics, the material itself may be likely to undergo deformations, thereby generating rejects. Moreover, many plastic materials have a softening point lying below Tₛ, so that they are not viable for use in connection with the above-described prior-art decorating method.

In the field of plastic frames for spectacles, to which reference will be made throughout the following description for reasons of greater simplicity, although this is certainly not meant to limit the scope of the present invention, a solution is known in this connection, as disclosed in the U.S. Pat. No. 5,980,588. Proposed in this publication is a plastic decoration method to be performed under cold conditions, in which pigments in an aqueous solution of a solvent are added to the ink. This solvent serves the purpose of activating the surface layer of the plastic frame and increasing the adhesiveness thereof, along with the adhesiveness of the support film, on which the ink with the pigments is deposited, in such a manner as to favour said pigments being transferred onto the surface of the plastic material. Upon conclusion of this step, the frame is introduced into an atmosphere of a low-boiling product which is a solvent for the pigments and maintained therein until the thus transferred pigments are fixed to the plastic material.

This method, further to its implying a not so desirable utilization of solvent products, has a major drawback in that it causes the plastic material to be exposed to said solvents, especially during the pigment fixing step of the method, and therefore to incur the risk of being damaged. Another drawback may be seen in the fact that the decoration applied on the spectacles frames may turn out as not showing a desirably deep or uniform hue, owing to inadequate fixing.

### SUMMARY OF THE INVENTION

It therefore is a main object of the present invention to provide a simple and effective hot-decoration method for plastic materials, in particular spectacles frames, regardless of the same plastic materials having generally low softening temperatures. This practically enables the decoration of plastic materials, such as cellulose acetate, which have a softening point that is too low to allow them to be methoded according to the afore described prior-art method.

Within this general object thereof, another purpose of the present invention is to provide a method that is capable of ensuring an optimum quality of the surface decoration thus obtained on the plastic materials methoded therewith.

According to the present invention, these aims are reached in a method incorporating such characteristics as recited in the appended claims. There are in particular two of these characteristics that deserve being specially stressed as being basic features of the present invention, i.e.:

in the first place, the use of a lacquer (or resin), which shall be referred to as the “receptive lacquer” from now on, of which advantage is taken of the property of becoming receptive to the dye at temperatures that are close to the glass-transition point;

in the second place, the fact that the dyes are caused to undergo sublimation by keeping them in an ambient at a pressure that is lower than the atmospheric one, and then heating them up to temperatures below the rated one.

The method mainly includes following steps:

a. applying the dyes (contained in inks) on a support (usually a support film) so as to define the decoration that has to be transferred onto the surface of the plastic material;

b. applying and soon after drying a coat of receptive lacquer, as above defined, on the article of plastic material to be decorated;

c. applying the dyed support film in contact with the laquered plastic material to be decorated so as to obtain an article-and-support film assembly;

d. introducing the article-and-support film assembly into an oven;

e. heating up the article-and-support film assembly to a temperature at which the lacquer, but not the plastic of the article is caused to soften;

f. lowering the pressure in the atmosphere of the oven where the article-and-support film assembly have been introduced, so as to cause the dye to sublimate, thus transferring the decoration from the support film onto the plastics.

In this connection, it should however be appreciated that the exact sequence of certain steps of the method, such as for instance e. and f. is basically irrelevant.

The features and advantages of the present invention shall anyway be more readily understood from the description that is given below by way of non-limiting example of a preferred, although not sole embodiment of the method of the present invention, as used to decorate spectacles frames.

### DETAILED DESCRIPTION OF THE INVENTION

A first step of the method according to the present invention consists in setting out on a support film (such as for instance a sheet of common paper, aluminium foil or pressed aluminized paper or a plastic film) the decoration to be transferred onto a spectacles frame. This can be obtained through the use of an ink containing “disperse” dyes, as defined hereinbefore, by for instance printing the decoration on the support film by means of ink-jet, lithographic, silk-screening or similar techniques, wherein, among the various types of disperse dyes available on the market, i.e. the low, medium and high sublimation-energy types, the first two ones are preferred for use within the scope of the present invention.

In a subsequent step of the method, a coat of transparent receptive lacquer is applied by a wet technique onto the surface of the plastic with which the spectacles frame to be decorated is made. The lacquer itself is then allowed to dry, for instance by air-drying or oven-drying techniques. Resins, either pure or mixed, can as well be used instead of said lacquer, provided that they share the property of becoming receptive to dyes under given conditions. Anyway, for reasons of greater simplicity, reference will solely be made to lacquer in the following description.

The lacquer used in this connection shall have particular properties. In the first place, it shall be capable of softening, and therefore becoming receptive, at a temperature that is lower than the softening temperature of the plastic material of the spectacles frame (an adequate margin in this connection may be considered as lying anywhere between 10° C. and 20° C.), so as to avoid the frame itself to be deformed. The lacquer shall also be able of maintaining optimum receptivity properties when, as this is described in greater detail further on, it is brought up to the temperature at which it begins to soften.

Through a trial-and-error procedure, in which various appropriate doses of additives such as for example plasticizers or catalysts are added to a lacquer normally available on the market, the glass-transition temperature of the same lacquer is suitably altered so as to bring it down below the glass-transition temperature of the plastic material with which the spectacles frame to be decorated is made.

The next step consists in arranging the support film in contact with the lacquered surface of the frame and then introducing the resulting frame-and-support film assembly into an oven. The oven is then heated up to a temperature T_{f}, which is lower (by approx. 10° C.) than the softening temperature of the plastic material, but is sufficient to cause the lacquer to soften in order to enable it to become receptive.

At this point, with the help of generally known means, a vacuum is created inside the oven, to such an extent as to enable the dyes to be caused to sublimate at said temperature T_{f}, i.e. when a condition T_{f}=Tₛ is reached. If very low pressure values (i.e. of approx. 10⁻⁶ bar) are thus created iside the oven, the sublimation temperature of the dye decreases to such an extent as to make it possible for even such plastics as cellulose acetate or polyamides to be used, which are largely known as preferred materials in the manufacture of low-cost frames.

By bringing the sublimation temperature Tₛ of the dye present on the support film to the oven temperature T_{f}, the decoration is caused to transfer from the support film on to the coat of lacquer and, ultimately, the spectacles frame. It clearly appears that the layer of receptive lacquer serves the purpose of providing the dye with a surface for it to be able to “catch hold”. The properties of the lacquer, as they have been indicated hereinbefore, are ensured by appropriately setting the glass-transition temperature thereof: if the lacquer occurs to soften to an excessive extent at the temperature T_{f} reached in the oven, the support film will stick to the frame; if on the contrary the lacquer does not soften much enough, it will have just a poor receptivity, thereby impairing the dye transfer results.

When the frame is eventually removed from the oven, and the support film is peeled off, the frame will show the desired decoration perfectly applied and set thereupon.

A different embodiment of the above-described method, which does not require a special oven fitted with an equipment for creating a vacuum, calls for the use of a container in which the articles to be decorated are hermetically enclosed. After a desired vacuum has been created inside the container, the same is then introduced into a conventional oven, where the sublimation of the decorating dyes will then take place.

It will be readily appreciated that the above-described method is subject to a number of conceptually minor variants and modifications without departing from the scope of the present invention as defined in the appended claims. In particular, when the plastic material with which the article is made has a high softening point as compared to the sublimation point, it is not needed to create a vacuum.

1. Surface-decorating method for an article made of a plastic material after manufacture, comprising the steps of:
applying a layer of lacquer or resin on said plastic material of the article, the said lacquer or resin being of a type able to become receptive at a temperature (T_{f}) that is lower than the softening point of said material,
laying down on said material a support comprising the decoration, and
heating up the assembly constituted by said support and said article in an ambient in which the pressure is lower than or equal to the atmospheric one, until the temperature (T_{f}) is reached, at which said lacquer or resin becomes receptive to facilitate the transfer of said decoration onto the article to be decorated.

2. Method according to claim 1, wherein said decoration consists of sublimatic dyes deposited onto said support.

3. Method according to claim 2, wherein said pressure being lower than or equal to the atmospheric one is selected and set so as to enable said dyes to have a sublimation temperature (Ts) equal to the temperature (T_{f}) at which said lacquer or resin becomes receptive.

4. Method according to claim 1, wherein the ambient in which the pressure is lower than or equal to the atmospheric one is an oven fitted with an equipment for creating a vacuum thereinside.

5. Method according to claim 1, wherein the ambient in which the pressure is lower than or equal to the atmospheric one is a hermetically sealed and heatable container.

6. Method according to claim 1, wherein said film-like support is a paper sheet, an aluminium foil, a pressed aluminized paper foil, a plastic film or the like.

7. Method according to claim 1, which comprises the use of plasticizers or catalysts, or similar additives, to alter the glass-transition temperature of said lacquer or resin, in particular to make said temperature lower than the softening point of the plastic material with which the article is made.

8. Method according to claim 1, which comprises the step of drying the coat of lacquer after the latter has been applied onto the material to be decorated.

9. Method according to claim 1, which comprises the use of cellulose acetate as a plastic material for the article to be decorated.

10. Method according to claims 1, which comprises the use of polyamides as a plastic material for the article to be decorated.

11. Spectacles frame made with a plastic material and bearing a surface-decoration obtained with the method according to any of the preceding claims.
